(19) United States
(12) Patent Application Publication
(10) Pub. No.: US 2012/0301714 A1
(43) Pub. Date: Nov. 29, 2012

(54) MULTILAYER STRUCTURE, AND A METHOD FOR MAKING THE SAME

(75) Inventors: Helen Lin Fang, Shanghai (CN); Hai Bo Fang, Shanghai (CN)

(73) Assignee: Dow Global Technologies LLC, Midland, MI (US)

(21) Appl. No.: 13/574,793

(22) PCT Filed: Jan. 27, 2010
(86) PCT No.: PCT/CN2010/070375

§ 371 Date: Jul. 24, 2012

(51) Int. Cl. B32B 15/092; B32B 27/08; B05D 1/36

(52) U.S. Cl. 428/339; 427/296; 428/416

(57) ABSTRACT

The instant invention is a multilayer structure, and a method for making the same. The multilayer structure comprises: (a) at least one substrate layer comprising a polymeric material; (b) at least one adhesion layer, wherein said adhesion layer is derived from an adhesion promoter composition comprising: at least one aqueous epoxy dispersion; at least one hardening agent; optionally at least one leveling agent; at least one toughening agent; and optionally at least one filler; and (c) at least one surface layer comprising a plating metal; wherein said adhesion layer is disposed therebetween said at least one substrate layer and said at least one surface layer.

### FIELD OF INVENTION

The instant invention relates to a multilayer structure, and a method for making the same.

### BACKGROUND OF THE INVENTION

The use of vacuum plating for decorating different materials is generally known. The relative metals for vacuum plating include, but are not limited to, Ti, Ni, Cu, and Cr. Vacuum plating typically can provide better adhesion while being more environmentally friendly than the other traditional plating processes. Vacuum platting on plastic materials such fiberglass reinforce nylon, however, suffers from poor adhesion properties and poor crack resistance properties.

Furthermore the thin layer of plating layer does not adequately cover substrate defects. The use of primer coating or ultraviolet (UV) coating has not provided optimum adhesion properties or crack resistance properties.

Accordingly, there is a need to provide a method for vacuum plating plastic substrates with improved crack resistance properties and adhesion properties, and such vacuum plated plastic substrates with improved crack resistance properties and adhesion properties.

### SUMMARY OF THE INVENTION

The instant invention is a multilayer structure, and a method for making the same.

In one embodiment, the instant invention provides a multilayer structure comprising: (a) at least one substrate layer comprising a polymeric material; (b) at least one adhesion layer, wherein said adhesion layer is derived from an adhesion promoter composition comprising: at least one aqueous epoxy dispersion; at least one hardening agent; optionally at least one leveling agent; at least one toughening agent; and optionally at least one filler; and (c) at least one surface layer comprising a plating metal; wherein said adhesion layer is disposed therebetween said at least one substrate layer and said at least one surface layer.

In an alternative embodiment, the instant invention further provides a method for making a multilayer structure comprising the steps of: (1) providing at least one substrate layer comprising a polymeric material; (2) providing an adhesion promoter composition comprising: at least one aqueous epoxy dispersion; at least one hardening agent; optionally at least one leveling agent; at least one toughening agent; and optionally at least one filler; (3) applying said adhesion promoter composition to said at least one substrate layer; (4) thereby forming a coated substrate layer comprising at least one adhesion layer associated with said at least one substrate layer; (5) vacuum plating at least one surface layer comprising a plating metal onto one surface of said coated substrate layer; (6) thereby forming said multilayer structure, wherein said adhesion layer is disposed therebetween said at least one substrate layer and said at least one surface layer.

In another alternative embodiment, the instant invention further provides an article comprising the inventive multilayer structure.

In an alternative embodiment, the instant invention provides a multilayer structure, method of making the same, articles made therefrom, in accordance with any of the preceding embodiments, except that the adhesion layer has a thickness in the range of from 5 to 50 μm.

In an alternative embodiment, the instant invention provides a multilayer structure, method of making the same, articles made therefrom, in accordance with any of the preceding embodiments, except that the adhesion promoter composition comprises from 20 to 65 percent by weight of the aqueous epoxy dispersion, wherein the adhesion promoter composition comprises from 20 to 50 percent by weight of said hardening agent, wherein the adhesion promoter composition comprises from 0.5 to 10 percent by weight of said toughening agent, and wherein the adhesion promoter composition optionally comprises from 0 to 10 percent by weight of said leveling agent, and wherein said adhesion promoter composition optionally comprises from 0.1 to 10 percent by weight of the at least one filler, based on the total weight of the adhesion promoter composition.

In an alternative embodiment, the instant invention provides a multilayer structure, method of making the same, articles made therefrom, in accordance with any of the preceding embodiments, except that the plating metal is selected from the group consisting of Zn, Al, Cr, Cu, Ti, and Ni.

In an alternative embodiment, the instant invention provides a multilayer structure, method of making the same, articles made therefrom, in accordance with any of the preceding embodiments, except that the polymeric material is a fiberglass reinforced nylon.

In an alternative embodiment, the instant invention provides a multilayer structure, method of making the same, articles made therefrom, in accordance with any of the preceding embodiments, except that the polymeric material is a pre-treated fiberglass reinforced nylon.

In an alternative embodiment, the instant invention provides a multilayer structure, method of making the same, articles made therefrom, in accordance with any of the preceding embodiments, except that the at least one surface layer comprising a plating metal has a thickness in the range of from 5 to 20 μm.

### DETAILED DESCRIPTION OF THE INVENTION

The instant invention is a multilayer structure, and a method for making the same. The multilayer structure according to the present invention comprises: (a) at least one substrate layer comprising a polymeric material; (b) at least one adhesion layer, wherein said adhesion layer is derived from an adhesion promoter composition comprising: at least one aqueous epoxy dispersion; at least one hardening agent; optionally at least one leveling agent; at least one toughening agent; and optionally at least one filler; and (c) at least one surface layer comprising a plating metal; wherein said adhesion layer is disposed therebetween said at least one substrate layer and said at least one surface layer.

The substrate layer comprises one or more polymeric materials. Such polymeric materials include, but are not limited to, polyolefins such as homopolymers of ethylene or propylene, or copolymers of ethylene or propylene and one or more alpha olefins; Acrylonitrile Butadiene Styrene (ABS), polycarbonate, nylon, poly(vinyl chloride), fiberglass reinforced nylon, polyethylene terephthalate (PET), Thermoplastic Elastomer (TPE), polyester, blends thereof and the like. The substrate layer may have a thickness in the range of at least 0.5 μm or greater; for example, the substrate layer may have a thickness in the range of at least 1 μm or greater; or in the alternative, the substrate layer may have a thickness in the range of at least 5 μm or greater; or in the alternative, the substrate layer may have a thickness in the range of at least 100 μm or greater; or in the alternative, the substrate layer may have a thickness in the range of at least 0.1 mm or greater; or in the alternative, the substrate layer may have a thickness in the range of at least 1 mm or greater; or in the alternative, the substrate layer may have a thickness in the range of at least 5 mm or greater. The substrate layer may comprise a single layer; or in the alternative, the substrate layer may comprise two or more layers. The substrate layer may be pretreated. Such pretreatments include, but are not limited to, acid treatment, sanding, ionizing, and solvent treatment.

The adhesion layer is derived from one or more adhesion promoter compositions. The adhesion promoter composition comprises at least one aqueous epoxy dispersion; at least one hardening agent; optionally at least one leveling agent; at least one toughening agent; and optionally at least one filler.

The aqueous epoxy dispersion is any water based epoxy dispersion. Such aqueous epoxy dispersions are, for example, available under the tradename XZ 92533.00 from The Dow Chemical Company, Midland, Mich. XZ 92533.00 is an epoxy resin, a modified bisphenol-A “1”-type solid epoxy resin, which is dispersed in water. The adhesion promoter composition may comprise from 10 to 90 percent by weight of the aqueous epoxy dispersion, based on the total weight of the adhesion promoter composition. For example, the adhesion promoter composition may comprise from 20 to 65 percent by weight of the aqueous epoxy dispersion, based on the total weight of the adhesion promoter composition; or in the alternative, from 35 to 45 percent by weight of the aqueous epoxy dispersion, based on the total weight of the adhesion promoter composition. Two or more aqueous epoxy dispersion may also be used in combinations. The aqueous epoxy dispersion has a epoxide equivalent weight in the range of 450 to 550 g/eq on solids, measured according to ASTM-D 1652; for example, 470 to 500 g/eq, measured according to ASTM-D 1652.

The hardening agent is a polyamine hardener. Such hardening agents are commercially available under the tradename Cardolite LX-5256 from Cardolite. The adhesion promoter composition may comprise 20 to 50 percent by weight of the hardening agent, based on the total weight of the adhesion promoter composition. For example, the adhesion promoter composition may comprise 30 to 45 percent by weight of the hardening agent, based on the total weight of the adhesion promoter composition; or in the alternative, 12 to 16 percent by weight of the hardening agent, based on the total weight of the adhesion promoter composition.

The leveling agent may be any suitable leveling agent. Such leveling agents are generally known, for example, polyether modified polysiloxane. Commercially available leveling agents include, but are not limited to, under the tradename BYK-301 from BYK Additives & Instruments Company. The adhesion promoter composition may optionally comprise from 0 to 5 percent by weight of one or more leveling agents; for example, from 0 to 1 percent by weight of one or more leveling agents; or the in the alternative, from 0 to 0.5 percent by weight of one or more leveling agents; or the in the alternative, from 0 to 0.3 percent by weight of one or more leveling agents.

The toughening agent may be any epoxy toughener; for example, the toughening agent may be a PEO/PBO toughening agent such as FORTEGRA™, which is commercially available from The Dow Chemical Company. The adhesion promoter composition may comprise from 0.1 to 10 percent by weight of the toughening agent, based on the total weight of the adhesion promoter composition. For example, the adhesion promoter composition may comprise from 2 to 7 percent by weight of the toughening agent, based on the total weight of the adhesion promoter composition; or in the alternative, from 3.5 to 5 percent by weight of the toughening agent, based on the total weight of the adhesion promoter composition.

The one or more optional fillers may be any filler. Such fillers include, but are not limited to, nano silicon dioxide fillers, commercially available from Nanjing Nano Materials Company, for example. The adhesion promoter composition optionally comprises from 0 to 10 percent by one or more fillers; for example, from 1 to 10 percent by one or more fillers; for example, from 1 to 8 percent by one or more fillers; for example, from 1 to 7 percent by one or more fillers; for example, from 1 to 5 percent by one or more fillers. Such filler may have an average particle size diameter in the range of from less than 60 nm; for example, 20 to 60 nm.

The adhesion promoter composition may comprise less than 95 percent by weight of water, e.g. deionized water (DI water); for example, from 10 to 90 percent by weight of water; or in the alternative, from 10 to 80 percent by weight water; or in the alternative, from 10 to 60 percent by weight of water; or in the alternative, from 10 to 50 percent by weight of water. In one embodiment, the adhesion promoter composition is free of any solvent.

In one embodiment, the adhesion promoter composition consist essentially of from 20 to 65 percent by weight of one or more aqueous epoxy dispersions, and from 20 to 50 percent by weight of one or more hardening agents, and from 0.5 to 10 percent by weight of one or more toughening agents, and optionally from 0 to 10 percent by weight of one or more leveling agents, and optionally from 0.1 to 10 percent by weight of one or more fillers, and from 10 to 80 percent by weight of water, based on the total weight of the adhesion promoter composition.

In one embodiment, the adhesion promoter composition is free of any volatile organic chemicals (VOCs). In another embodiment, the adhesion promoter composition is free of any halogen, e.g. chlorine.

In an adhesion promoter composition production, the adhesion promoter composition may be prepared by blending the required components via any method; for example, the adhesion promoter composition may be prepared via a mixer, such as blade disk type, at a mixing blade speed of, for example, 100 to 1000 rpm, for approximately 30 to 60 minutes or until all the ingredients are well dispersed.

The method for making the inventive multilayer structure comprises the steps of: (1) providing at least one substrate layer comprising a polymeric material; (2) providing an adhesion promoter composition comprising: at least one aqueous epoxy dispersion; at least one hardening agent; optionally at least one leveling agent; at least one toughening agent; and optionally at least one filler; (3) applying said adhesion promoter composition to said at least one surface of the substrate layer; (4) thereby forming a coated substrate layer comprising at least one adhesion layer associated with said at least one surface of the substrate layer; (5) vacuum plating at least one surface layer comprising a plating metal onto one surface of said coated substrate layer; and (6) thereby forming said multilayer structure, wherein said adhesion layer is disposed therebetween said at least one substrate layer and said at least one surface layer.

In multilayer structure production, a substrate layer as well as an adhesion promoter composition is provided. The adhesion promoter composition is applied to at least one surface of the substrate layer. The adhesion promoter composition may be applied to at least one surface of a substrate via any method. Such methods include but are not limited to, spraying, dipping, roll coating, blade coating, curtain coating, printing techniques such as flexography and rotogravure, size press, metered size press, screen coating, rod coating combinations thereof, and the like. The adhesion promoter composition may be applied to the substrate layer in any amount. For example, the adhesion promoter composition may be applied to substrate layer in an amount to produce one or more adhesion layers, wherein each adhesion layer has a coat weight, based on the dry weight of the solid content of the adhesion promoter composition, in the range of 1 g per m² of the base layer to 2000 g per m² of the substrate layer, or in the range of 1 g per m² of the base layers to 500 g per m² of the substrate layers, or in the range of 1 g per m² of the substrate layers to 250 g per m² of the base layers, in the range of 1 g per m² of the substrate layers to 100 g per m² of the base layers. After one or more surfaces of a substrate layer are coated with the adhesion promoter composition, the adhesion promoter composition may be flash dried and then cured. The curing may be conducted via any conventional method. Such conventional drying methods include but, are not limited to, air drying, convection oven drying, hot air drying, microwave oven drying, and/or infrared oven drying. The curing may be conducted at any temperature; for example, the drying may be conducted at a temperature in the range of from 0° C. to 200° C.; for example from 25° C. to 125° C., or in the alternative, from 80° C. to 120° C. The cure time may range from greater than 0 to 5 hours; for example, from greater than 0 to 2 hours; or in the alternative, from 20 to 40 minutes. The adhesion layer formed may have a thickness in the range of from 1 to 100 μm, for example, from 5 to 50 μm; or in the alternative, from 5 to 50 μm.

After the adhesion layer is formed onto one or more surfaces of the substrate layers, one or more surface layers comprising one or more plating metals are plated, for example vacuum plated, thereto; thus forming a multilayer structure, wherein the adhesion layer is disposed therebetween the substrate layer and the one or more surface layers. The vacuum plating is generally known to a person of ordinary skill in the art. In vacuum plating process, one or more thin films are deposited by the condensation of a vaporized form of one or more metals onto the adhesion layer to form, for example, semiconductor wafers or plastics.

The multilayer structure of the resent invention has improved crack resistance after vacuum plating while marinating optimized adhesion properties. The multilayer structures of the present invention have no visual observable cracks. The adhesion between the adhesion layer and the substrate layer is in the range of from greater than 4 B, for example 5 B or greater, measured according to ASTM-D 3359-2002. The adhesion between the adhesion layer and a surface layer is in the range of from greater than 4 B, for example 5 B or greater, measured according to ASTM-D 3359-2002. The multilayer structure may have a hardness, measured according to GB/T 6739-1996, in the range of equal or greater than 3 H.

The multilayer structure of the present invention may be formed into articles such as automobile parts, hand-held appliances, bathroom hardware and accessories, electronic goods, or architectural goods.

### EXAMPLES

The following examples illustrate the present invention but are not intended to limit the scope of the invention. The examples of the instant invention demonstrate that the multilayer structures of the present invention have no visually observable cracks after vacuum plating while maintaining acceptable adhesion properties.

### Inventive Example 1-3

The formulation components reported in Table I. The FORTEGRA™ 100 was slowly added at a rate of 1 g/minute into the deionized water and dispersed via a high shear mixer at approximately 700 to 1000 rpm for approximately 10 minutes at 25° C. to form a 10% solution of FORTEGRA^{TM} 100. The 10% solution of FORTEGRA™ 100 was added into the aqueous epoxy dispersion under low-speed mixing of approximately 200 RPM. Molded handles comprising fiberglass reinforced nylon substrate were provided. In example 1, the molded handle comprising fiberglass reinforced nylon substrate was pretreated with 2 mol/1H₂SO₄ for 1 minute, and then washed with water and dried at 50° C. oven for 2 hours. In examples 2 and 3, molded handles comprising fiberglass reinforced nylon substrates are not pretreated. The adhesion promoter composition 1-3 were each applied to a molded handle, as described above, via spray coating or dip coating, and flash dried at room temperature for 5 minutes. The coated molded handles were placed in an oven, and cured at heating conditions reported in Table I; thereby, forming an adhesion layer associated with the molded handle, wherein the adhesion layer had a thickness in the range of 20 to 25 μm. A plating metal was vacuum plated onto the coated/cured surface of molded handle. The vacuum plating was carried out in a vacuum plating chamber at 140° C. plating temperature for 15 minutes, wherein the temperature of the coated/cured molded handle was raised to approximately 40° C. The plating metal had a thickness of approximately 5 to 20 um. Various properties of the inventive molded handles 1-3 were measured, and they are reported in Table II.

### Comparative Example A-D

The formulation components reported in Table III were admixed via a high shear mixer at approximately 700 to 1000 rpm for approximately 30 minutes at 25° C. to form the comparative adhesion promoter compositions A-D. Molded handles comprising fiberglass reinforced nylon substrate were provided. In comparative example D, the molded handle comprising fiberglass reinforced nylon substrate was pretreated with 2 mol/1H₂SO₄ for 1 minute, and then washed with water and dried at 50° C. oven for 2 hours. In comparative examples A, B, and C, molded handles comprising fiberglass reinforced nylon substrates are not pretreated. The comparative adhesion promoter compositions A-D were each applied to a molded handle, as described above, via spray coating or dip coating, and then flash dried at room temperature for 5 minutes, thereby, forming comparative coated molded handles A-D. Each one of the comparative coated molded handles A-D was placed in an oven, and cured at heating conditions reported in Table III; thereby, forming a comparative adhesion layer associated with each molded handles A-D, wherein each comparative adhesion layer had a thickness in the range of 20 to 25 μm. A plating metal was vacuum plated onto each comparative coated/cured molded handles A-D. The vacuum plating was carried out in a vacuum plating chamber at 140° C. plating temperature for 15 minutes, wherein the temperature of each comparative coated/cured molded handles A-D was raised to approximately 40° C. The plating metal had a thickness of approximately 5 to 20 μm. Various properties of the comparative molded handles were measured, and they are reported in Table W.

The present invention may be embodied in other forms without departing from the spirit and the essential attributes thereof, and, accordingly, reference should be made to the appended claims, rather than to the foregoing specification, as indicating the scope of the invention.

TABLE I

| Components | Inventive 1 | Inventive 2 | Inventive 3 |
|---|---|---|---|
| XZ 92533.00 | 100 | 100 | 100 |
| Cardolite NC 541LV | 90.75 | 121 | 90.75 |
| FORTEGRA ™ | 25 | 50 | 25 |
| (10% Solution | | | |
| in DI Water) | | | |
| DI Water | 93.3 | 87.8 | 102 |
| Heat Conditions | ~100° C. for | ~120° C. for | ~100° C. for |
| | 30 minutes | 30 minutes | 30 minutes |
| Molded Handle | H2SO4 | No H2SO4 | No H2SO4 |
| Substrate | Pretreatment | Pretreated | Pretreated |

TABLE II

| | | Inven- | Inven- | Inven- |
|---|---|---|---|---|
| Measured Property | Test Method | tive 1 | tive 2 | tive 3 |
| Adhesion Between | ASTM-D 3359-2002 | 5B | 5B | 5B |
| Adhesion Layer | | | | |
| and Substrate | | | | |
| Hardness | GB/T 6739 1996 | 2H | 3H | 3H |
| Adhesion Between | ASTM-D 3359-2002 | 5B | 5B | 4B |
| Adhesion Layer | | | | |
| and Plating Layer | | | | |
| *Crack After | Visual | 3 | 3 | 3 |
| Vacuum Plating | Determination | | | |

1 = Obvious visible cracks; 2 = small cracks observed under 200X microscope; and 3 = no cracks observed.

TABLE III

| Components | Comparative A | Comparative B | Comparative C | Comparative D |
|---|---|---|---|---|
| D.E.R ™ 331 | 50 | — | — | — |
| XZ 92533.00 | — | 100 | 100 | — |
| Cardolite NC 541LV | 30 | 121 | — | — |
| FORTEGRA ™ | — | — | 25 | — |
| Anquamine 419 | — | — | 21.3 | — |
| polypropyl methyl | 2 | — | — | — |
| ether | | | | |
| xylene | 10 | — | — | |
| Polyurethane | — | — | — | 50 |
| Dispersion | | | | |
| DI Water | — | 137.8 | 60 | — |
| Heat Conditions | ~100° C. for | ~80° C. for | ~100° C. for | ~25° C. for |
| | 30 minutes | 30 minutes | 30 minutes | 24 hours |
| Molded handle | No H2SO4 | No H2SO4 | No H2SO4 | H2SO4 |
| Substrate | Pretreated | Pretreated | Pretreated | Pretreated |

TABLE IV

| | | Comparative | Comparative | Comparative | Comparative |
|---|---|---|---|---|---|
| Measured Property | Test Method | A | B | C | D |
| Adhesion Between | ASTM-D 3359-2002 | 1B | 5B | 4B | 1B |
| Adhesion Layer | | | | | |
| and Substrate | | | | | |
| Hardness | GB/T 6739 1996 | 2H | 3H | 2H | HB |
| Adhesion Between | ASTM-D 3359-2002 | 1B | 2B | 1B | 1B |
| Adhesion Layer | | | | | |
| and Plating Layer | | | | | |
| *Crack After | Visual | 1 | 1 | 1 | 1 |
| Vacuum Plating | Determination | | | | |

1 = Obvious visible cracks; 2 = small cracks observed under 200X microscope; and 3 = no cracks observed.

1. A multilayer structure comprising:
at least one substrate layer comprising a polymeric material;
at least one adhesion layer, wherein said adhesion layer is derived from an adhesion promoter composition comprising:
at least one aqueous epoxy dispersion;
at least one hardening agent;
at least one toughening agent;
optionally at least one filler; and
optionally at least one leveling agent; and
at least one surface layer comprising a plating metal;
wherein said adhesion layer is disposed there between said at least one substrate layer and set at least one surface layer.

2. The multilayer structure of claim 1, wherein said adhesion layer has a thickness in the range of from 5 to 50 μm.

3. The multilayer structure of claim 1, wherein the adhesion promoter composition comprises from 20 to 65 percent by weight of the aqueous epoxy dispersion, from 20 to 50 percent by weight of said hardening agent, and from 0.5 to 10 percent by weight of said toughening agent, based on the total weight of the adhesion promoter composition.

4. , The multilayer structure of claim 1, wherein the adhesion promoter composition comprises from 20 to 50 percent by weight of water, based on the total weight of the adhesion promoter composition.

5. The multilayer structure of claim 1, wherein the plating metal is selected from the group consisting of Zn, Al, Cr, Cu, Ti, and Ni.

6. The multilayer structure of claim 1, wherein the polymeric material is a fiberglass reinforced nylon.

7. The multilayer structure of claim 1, wherein the at least one surface layer comprising a plating metal has a thickness in the range of from 5 to 20 μm.

8. A method for making a multilayer structure comprising the steps of:
providing at least one substrate layer comprising a polymeric material;
providing an adhesion promoter composition comprising:
at least one aqueous epoxy dispersion;
at least one hardening agent;
at least one toughening agent;
optionally at least one filler; and
optionally at least one leveling agent;
applying said adhesion promoter composition to said at least one substrate layer:
thereby forming a coated substrate layer comprising at least one adhesion layer associated with said at least one substrate layer;
vacuum plating at least one surface layer comprising a plating metal onto said coated substrate layer;
thereby forming said multilayer structure, wherein said adhesion layer is disposed therebetween said at least one substrate layer and said at least one surface layer.

9. An article comprising the multilayer structure of claim 1.
